(19) United States
(12) Patent Application Publication
(10) Pub. No.: US 2005/0110873 A1
(43) Pub. Date: May 26, 2005

(54) Image pickup apparatus

(75) Inventor: Shigeo Enomoto, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/981,791

(22) Filed: Nov. 5, 2004

(30) Foreign Application Priority Data
Nov. 21, 2003 (JP) P2003-392051
May 18, 2004 (JP) P2004-148214

(51) Int. Cl. H04N 5/76; H04N 5/225

(52) U.S. Cl. 348/207.99; 386/117

(57) ABSTRACT

An image pickup apparatus comprises a photographing optical system, an imaging-device board having an imaging device, a stationary base, a pair of first support plates, a movable frame, and a pair of second support plates. The movable frame encloses the optical axis. The first and second support plates are disposed parallel to the optical axis of the photographing optical system. Front-end portions of the first and second support plates are connected to the movable frame. Rear-end portions of the first support plates are supported by the base. Rear-end portions of the second support plates are supported by the imaging-device board. The first and second support plates have piezoelectric actuators.

### BACKGROUND OF THE INVENTION

1. Field of the Invention

The present invention relates to an image pickup apparatus which can compensate an image shake caused by shaking of a camera.

2. Description of the Related Art

Conventionally, there is known a camera or an image pickup apparatus, which is provided with an image-shake compensating device, which corrects or compensates an image shake caused by a camera shake when performing a photographing operation. The conventional image-shake compensating device drives a compensating optical system in accordance with the camera shake to compensate the image shake, as disclosed in Japanese Patent No. 2,641,172.

In the image-shake compensating device, however, image quality is decreased because of an aberration occurring due to an offset of the compensating optical system. Further, since the image-shake compensating device is constructed in such a manner that the optical system is moved, the actuator for moving the optical system is required to have a large driving force, because of the weight and the friction. Thus, it is difficult to carry out an exact compensating control, and the electric power consumption is large. Further, a precise manufacturing process and advanced assembling technology are needed so that a gap or play in the sliding portion of the compensating optical system does not affect the compensating performance. This increases the manufacturing cost.

### SUMMARY OF THE INVENTION

Therefore, an object of the present invention is to provide an image pickup apparatus which displaces the imaging-device board in a plane perpendicular to the optical axis of the photographing optical system so that friction and a gap or play, are not generated, enabling an image-shake compensating control and so on to be effectively performed.

According to the present invention, there is provided an image pickup apparatus comprising a photographing optical system, an imaging-device board, a stationary base, a pair of first support plates, a movable frame, and a pair of second support plates.

The imaging-device board is provided with an imaging device for sensing an object image captured by the photographing optical system. The first support plates are disposed parallel to each other with respect to the optical axis of the photographing optical system, and have first rear-end portions that are supported by the base. The movable frame is supported by a first front-end portion of each of the first support plates, and that encloses the optical axis. The second support plates are disposed parallel to each other with respect to the optical axis, and are perpendicular to the first support plates. The second support plates have second front-end portions that are supported by the movable frame, and second rear-end portions that support the imaging-device board.

At least one of the first support plates has a piezoelectric actuator that bends, by applying an electric voltage to the piezoelectric actuator, to displace the movable frame relative to the base in a first direction perpendicular to the optical axis. At least one of the second support plates has a piezoelectric actuator that bends, by applying an electric voltage to the piezoelectric actuator, to displace the imaging-device board relative to the movable frame in a second direction perpendicular to the optical axis and the first direction.

### BRIEF DESCRIPTION OF THE DRAWINGS

The objects and advantages of the present invention will be better understood from the following description, with reference to the accompanying drawings in which:

FIG. 1 is a perspective view showing a first embodiment of an image pickup apparatus of the present invention;

FIG. 2 is a side view of the image pickup apparatus shown in FIG. 1;

FIG. 3 is an enlarged side view showing a state in which a second support plate is bent;

FIG. 4 is a block diagram showing a circuit of a control unit which carries out an image-shake compensating control in the image pickup apparatus shown in FIG. 1;

FIG. 5 is a perspective view showing a second embodiment of an image pickup apparatus of the present invention;

FIG. 6 is a side view, partly in cross-section, of the image pickup apparatus shown in FIG. 5;

FIG. 7 is a side view, partly in cross-section, in which the first support plates are bent from a state shown in FIG. 6; and

FIG. 8 is a perspective view, partly in cross-section, showing a third embodiment of an image pickup apparatus of the present invention.

### DESCRIPTION OF THE PREFERRED EMBODIMENTS

The present invention will be described below with reference to the embodiments shown in the drawings.

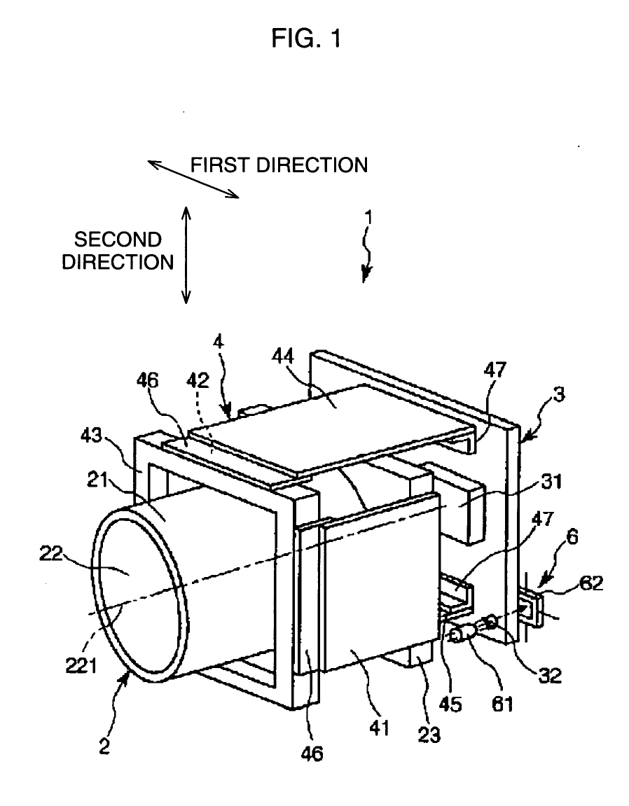

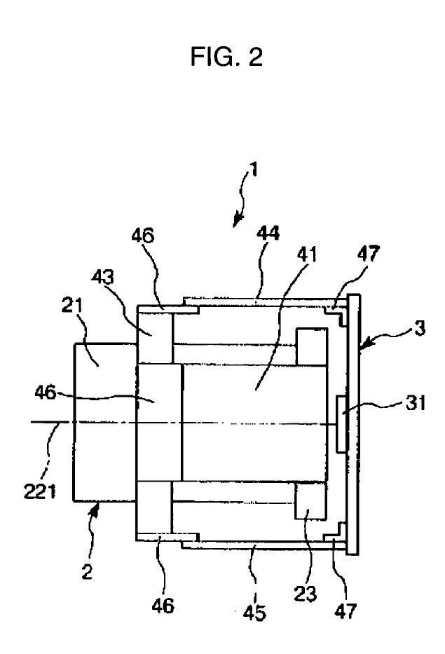

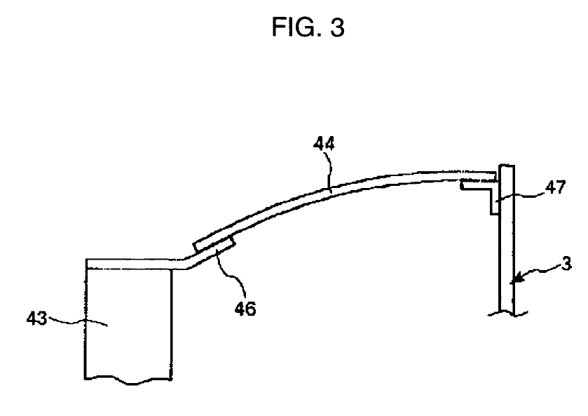

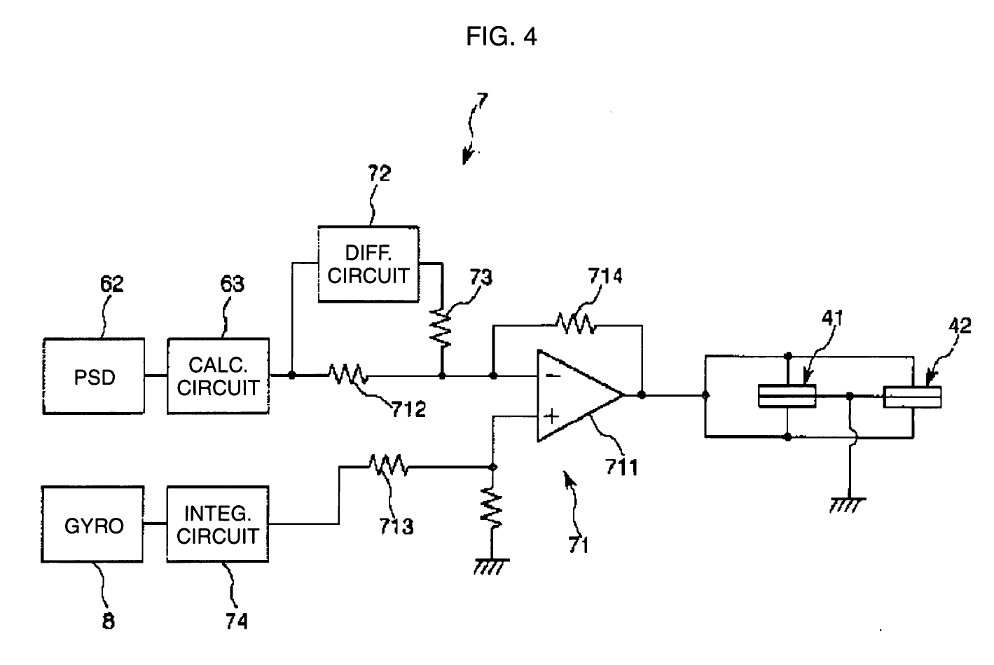

FIG. 1 is a perspective view showing a first embodiment of an image pickup apparatus 1 of the present invention, and FIG. 2 is a side view of the image pickup apparatus 1. FIG. 3 is an enlarged side view showing a state in which a second support plate is bent, and FIG. 4 is a block diagram showing a circuit of a control unit performing an image-shake compensating control in the image pickup apparatus shown in FIG. 1. Note that an upper side, a lower side, a left side, and a right side in FIG. 1 are respectively, an upper side, a lower side, a front side, and a rear side of the apparatus.

The image pickup apparatus 1 can be mounted in an optical device, such as an electronic still camera, binoculars provided with an electronic still camera, a telescope provided with an electronic still camera, and so on. The image pickup apparatus 1 has a photographing lens barrel 2, an imaging-device board 3, and a support mechanism 4 for supporting the imaging-device board 3.

The photographing lens barrel 2 has a cylindrical barrel body 21, and a photographing optical system 22 housed in the barrel body 21. The barrel body 21 is fixed in the optical device body (not shown), in which the image pickup apparatus 1 is housed, such that the barrel body 21 is not moved. Namely, a base 23, which is a rectangular flange provided at a rear-end portion of the barrel body 21, is rigidly fixed to a stationary portion in the optical device body.

The imaging-device board 3 is disposed behind the photographing lens barrel 2. The imaging-device board 3 is provided with an imaging device 31, such as a CCD or a CMOs sensor, which senses an object image captured by the photographing optical system 22.

The imaging-device board 3 is supported by the support mechanism 4 in such a manner that the imaging-device board 3 can be displaced, relative to the base 23, in a plane perpendicular to the optical axis 221 of the photographing optical system 22. The support mechanism 4 is described below in detail.

The support mechanism 4 has a pair of first support plates 41, 42, a movable frame 43, and a pair of second support plates 44, 45.

The first support plates 41, 42 are thin plates, and are disposed parallel to each other with respect to the optical axis or the optical path (i.e., the barrel body 21) of the photographing optical system 22. The first support plates 41, 42 are bimorph piezoelectric actuators.

First rear-end portions of the first support plates 41, 42 are supported by the base 23. The rear-end portions are connected to the base 23 through adhesive and so on, however, other connection methods can be used.

The movable frame 43 is supported by first front-end portions of the first support plates 41, 42. The movable frame 43 is a rectangular or square frame, and encloses the optical axis or the optical path (i.e., the barrel body 21) of the photographing optical system 22.

Two sides of the movable frame 43, which are parallel to each other, are connected to the first front-end portions of the first support plates 41, 42 through first flexible connecting members 46. The first flexible connecting members 46 can be fixed to the movable frame 43 and the first support plates 41, 42 through adhesive. The first flexible connecting members 46 may have elasticity so that the first flexible connecting members 46 can be restored to the original shape by removing the force applied thereto, or may not have elasticity.

As shown in FIG. 2, the second support plates 44, 45 are thin plates, and are disposed parallel to each other with respect to the optical axis or the optical path (i.e., the barrel body 21) of the photographing optical system 22, and perpendicular to the first support plates 41, 42. The second support plates 44, 45 are bimorph piezoelectric actuators.

Second front-end portions of the second support plates 44, 45 are supported by the movable frame 43. The second front-end portions are connected to two sides of the movable frame 43 through the first flexible connecting members 46. The two sides of the movable frame 43 are perpendicular to the two sides to which the first support plates 41, 42 are connected. The first flexible connecting members 46 can be fixed to the movable frame 43 and the second support plates 44, 45 through adhesive.

Second rear-end portions of the second support plates 44, 45 support the imaging-device board 3. The second rear-end portions are connected to the imaging-device board 3 through attaching members 47 having L-shape sections. The attaching members 47 can be connected to the imaging-device board 3 and the second support plate 44 or 45 through adhesive.

As shown in FIG. 3, since the second support plate 44 is formed of the bimorph piezoelectric actuator, the second support plate 44 is bent in a thickness direction by applying an electric voltage thereto, and is bent in the opposite direction by applying an electric voltage in the opposite direction. The second support plate 45 has the same construction as that of the second support plate 44, and the second support plates 44, 45 are applied to the voltages such that these plates 44, 45 are bent in the same direction.

Similarly, the first support plates 41, 42 are bent in the same direction as each other when applying an electric voltage. Note that FIG. 3 is exaggerated for the explanation, so that the second support plate 44 is indicated to be bent greatly, which cannot occur actually.

When the first support plates 41, 42, or the second support plates 44, 45 are bent, the flexible connecting members 46 are deflected, so that inclinations of the first support plates 41, 42, or the second support plates 44, 45 relative to the movable frame 43 are absorbed (see FIG. 3). In this embodiment, the flexible connecting members 46 are provided, and thus, the inclinations can be absorbed by a simple structure. Therefore, the imaging-device board 3 can be smoothly and exactly displaced.

Instead of the above, it is possible that the front-end portions of the first support plates 41, 42, and the second support plates 44, 45 are directly fixed to the movable frame 43, and that the rear-end portions of the first support plates 41, 42, and the second support plates 44, 45 are connected to the base 23 and the imaging-device board 3 through connecting members having flexibility, so that the inclination, occurring due to the bend, is absorbed at the rear ends of the first support plates 41, 42, and the second support plates 44, 45.

Further, a hinge structure, other than the flexible connecting members described above, can be utilized so that the inclinations of the front-end portions or the rear-end portions of the first support plates 41, 42, and the second support plates 44, 45 are absorbed.

As shown in FIG. 1, when the center of the movable frame 43 coincides with the optical axis 221, the first support plates 41, 42 are parallel to the optical axis 221. In this state, if an electric voltage is applied to the first support plates 41, 42 in a predetermined direction, the first support plates 41, 42 are bent, so that the movable frame 43 is displaced relative to the base 23 in a first direction (right or left direction in FIG. 1). The first direction is parallel to a plane perpendicular to the optical axis 221, and is perpendicular to the first support plates 41, 42 that are set to be parallel to the optical axis 221. Conversely, when an electric voltage is applied to the first support plates 41, 42 in the opposite direction to the predetermined direction, the movable frame 43 is displaced in the opposite direction to the first direction relative to the base 23.

Even when the first support plates 41, 42 are bent, the movable frame 43 is not displaced relative to the base 23, in a second direction which is parallel to a plane perpendicular to the optical axis 221, and perpendicular to the first direction. Therefore, the movable frame 43 is smoothly and exactly displaced in the first direction without shaking in the second direction.

When the centers of the movable frame 43 and the imaging device 31 coincide with the optical axis 221, the second support plates 44,45 are parallel to the optical axis 221. In this state, if an electric voltage is applied to the second support plates 44, 45 in a predetermined direction, the second support plates 44, 45 are bent, so that the movable frame 43 is displaced relative to the base 23 in a second direction (up or down direction in FIG. 1), which is perpendicular to the first direction. Conversely, when an electric voltage is applied to the second support plates 44, 45 in the opposite direction to the predetermined direction, the imaging-device board 3 is displaced in the opposite direction to the second direction relative to the movable frame 43.

Even when the second support plates 44, 45 are bent, the imaging-device board 3 is not displaced relative to the movable frame 43, in the first direction. Therefore, the imaging-device board 3 is smoothly and exactly displaced in the second direction without shaking in the first direction.

As described above, regarding the support mechanism 4, the movable frame 43 can be displaced relative to the base 23 in the first direction, and the imaging-device board 3 can be displaced relative to the movable frame 43 in the second direction. Therefore, the imaging-device board 3 can be displaced from a center position, at which the center of the imaging device 31 is coincident with the optical axis 221, in the first direction and in the second direction. Namely, the imaging-device board 3 can be displaced in a plane perpendicular to the optical axis 221, in the optical device body.

Further, in the support mechanism 4, the first support plates 41, 42 and the second support plates 44, 45 are bimorph piezoelectric actuators, which can displace the imaging-device board 3 in any direction in a plane perpendicular to the optical axis 221. Therefore, no other actuator need be provided, so that the construction can be simplified and miniaturized.

The image pickup apparatus 1 has a displacement detecting unit 6, which detects a displacement amount of the imaging-device board 3 or the imaging device 31 from the center position. The displacement detecting unit 6 has a light-emitting element 61, such as a light-emitting diode, emitting a detecting light beam toward a small hole 32 formed in the imaging-device board 3, and a two-dimensional PSD (Position Sensitive Detector) 62, detecting a position of the beam spot formed by the detecting light beam passing through the small hole 32. The light-emitting element 61 and the two-dimensional PSD 62 are fixed in the optical device body so as not to move. When the imaging-device board 3 is displaced in the first and second directions, the incident position of the beam spot on the light-receiving surface of the two-dimensional PSD 62 is changed in the first and second directions. Thus, the displacement detecting unit 6 can detect the displacement amounts in the first and second directions of the imaging-device board 3.

A signal output from the two-dimensional PSD 62 is input to a calculating circuit (or PSD signal processing circuit) 63 (see FIG. 4). The calculating circuit 63 outputs a voltage signal indicating the displacement amounts of the imaging-device board 3.

The image pickup apparatus 1 has a control unit 7 (see FIG. 2) that applies an electric voltage to the first support plates 41, 42 and the second support plates 44, 45 to control the position of the imaging-device board 3 so that an image shake is compensated when the imaging device 31 senses the object image. The control unit 7 has a first controller controlling the first support plates 41, 42, and a second controller controlling the second support plates 44, 45. Since both of the first and second controllers have the same structures, only the first controller will be described below.

As shown in FIG. 4, the first controller of the control unit 7 has a differential amplifier 71, which has an operational amplifier 711, a resistor 712 connected to the inverting input terminal of the operational amplifier 711, a resistor 713 connected to the non-inverting input terminal of the operational amplifier 711, and a feedback resistor 714, which sends negative-feedback from the output side of the operational amplifier 711 to the input side thereof. The first support plates 41, 42 are connected to the output terminal of the differential amplifier 71.

A signal, which is output from the calculating circuit 63 and indicates the displacement amount in the first direction of the imaging-device board 3, is input to the inverting input terminal of the operational amplifier 711 through the resistor 712. This signal is also input to a differentiation circuit 72, and is differentiated therein, so that a velocity signal indicating a moving velocity of the imaging-device board 3 in the first direction is generated. The velocity signal is input to the inverting input terminal of the operational amplifier 711 through the resistor 73.

A gyro-sensor or angular velocity sensor 8 is provided in the optical device body. A signal, which is output from the gyro-sensor and which indicates a camera shake velocity in the first direction, is input to an integrating circuit 74, and is integrated therein, so that a camera-shake signal indicating a camera-shake amount in the first direction is generated. The camera-shake signal is input to the non-inverting input terminal of the operational amplifier 711 through the resistor 713.

Due to such a construction, a voltage, which is in proportion to the difference between the camera-shake amount in the first direction and the displacement amount of the imaging-device board 3 in the first direction, is applied to each of the first support plates 41, 42, so that the first support plates 41, 42 are bent. As a result, the imaging-device board 3 is displaced in the first direction in accordance with the camera-shake amount in the first direction, so that the image shake in the first direction, occurring when the imaging device 31 senses the object image, is compensated.

Further, in the embodiment, the differentiation circuit 72 and the resistor 73 are provided, and the velocity signal of the imaging-device board 3 in the first direction is fed back. Due to this, even when the camera-shake velocity is high, the camera-shake compensation control is stably and exactly performed.

An electric control of each of the second support plates 44, 45 is carried out in a similar way as the above. Thus, the imaging-device board 3 is displaced in the second direction in accordance with the camera-shake amount in the second direction, so that the image shake in the second direction, occurring when the imaging device 31 senses the object image, is similarly compensated.

The control unit 7 is an analogue controller composed of analogue electronic circuits, as described above. However, the control unit 7 can be a digital controller executing a control algorithm using software or a program.

In the embodiment, since the bending characteristics of the bimorph piezoelectric actuators, which are the first support plates 41, 42 and the second support plates 44, 45, have hysteresis and resonance characteristics, a feedback control, such as that described above, is needed, and therefore, a positioning sensor such as the two-dimensional PSD 62 is provided. However, if the resonance frequency is high enough in comparison with the camera-shake frequency, and a drop of the accuracy, occurring because of the hysteresis, is within an allowable range of the image-shake compensating control, the feedback control and the positioning sensor are unnecessary. In this case, the construction for performing the image-shake compensating control can be more simplified.

The support mechanism 4 provided in the image pickup apparatus 1 is not provided with a mechanism in which some members are slidably or otherwise engaged with each other. Therefore, when the imaging-device board 3 is displaced in a plane perpendicular to the optical axis 221, friction or play does not occur in the support mechanism 4, and the imaging-device board 3 does not incline, so that the imaging-device board 3 is smoothly displaced with high accuracy. Thus, since friction or play is prevented from affecting the accuracy of the compensation control, and thereby making the control unstable, the image-shake compensation control is always carried out with a high accuracy.

Since the support mechanism 4 functions as an actuator, which displaces the imaging-device board 3, it is not necessary to provide a specific actuator. Accordingly, the construction for performing the image-shake compensating control can be simplified and miniaturized.

Further, since the support mechanism 4 is light, the inertia regarding the displacement of the imaging-device board 3 is small. Accordingly, an image-shake compensation control, which is smooth and stable, is easily attained. Furthermore, since friction resistance is low, regarding the displacement of the imaging-device board 3, due to the characteristics of the image-shake compensation control, electric power consumption for the image-shake compensation control can be reduced.

Since the support mechanism 4 is disposed to enclose the optical path (i.e., the photographing lens barrel 2) of the photographing optical system 22, a space for mounting the support mechanism 4 is small. Thus, in comparison with a case in which the support mechanism 4 is disposed around or behind the imaging-device board 3, the mounting space for the support mechanism 4 is easily obtained or formed. Therefore, the image pickup apparatus 1 is miniaturized, and thus, the size of the optical device to which the image pickup apparatus 1 is mounted, is reduced.

Further, since the structure of the support mechanism 4 is simple, that is to say, has a small number of members, and is easily assembled, the manufacturing cost can be reduced.

Note that, when the imaging-device board 3 is displaced in the first or second direction, the imaging-device board 3 is slightly displaced in the direction of the optical axis 221, so that a blur can occur in the image formed on the imaging device 31. However, the blur is so small that it can to be ignored, as described below.

For example, when the size of the imaging device 31 is 1/3 inch, the focal length of the photographing optical system 22 is 50 mm (250 mm, if converted to 35 mm format), and the F-number is F4, the displacement amount of the imaging-device board 3 driven under the image-shake compensation control is approximately ±0.3 mm at most. In this condition, when the imaging-device board 3 is displaced by 0.3 mm in the second direction, the imaging-device board 3 moves toward the photographing optical system 22 by 15 μm if the length of each of the second support plates 44 and 45 in the optical axis 221 is 20 mm. Due to this, the blur of the image is increased by 4 μm, which can be ignored. On the other hand, when the imaging-device board 3 is displaced in the first direction, the imaging-device board 3 is displaced to move away from the photographing optical system 22. Therefore, if the imaging-device board 3 is displaced in the first and second directions, the displacement amounts of the imaging-device board 3 in the direction of the optical axis 221 cancel each other out, so that the blur of the image is decreased.

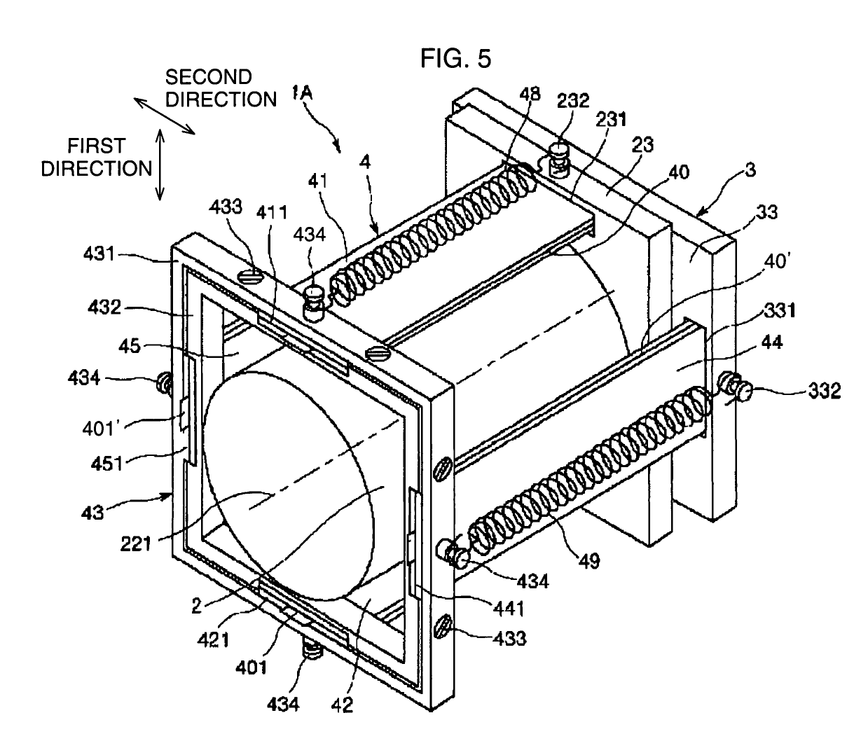

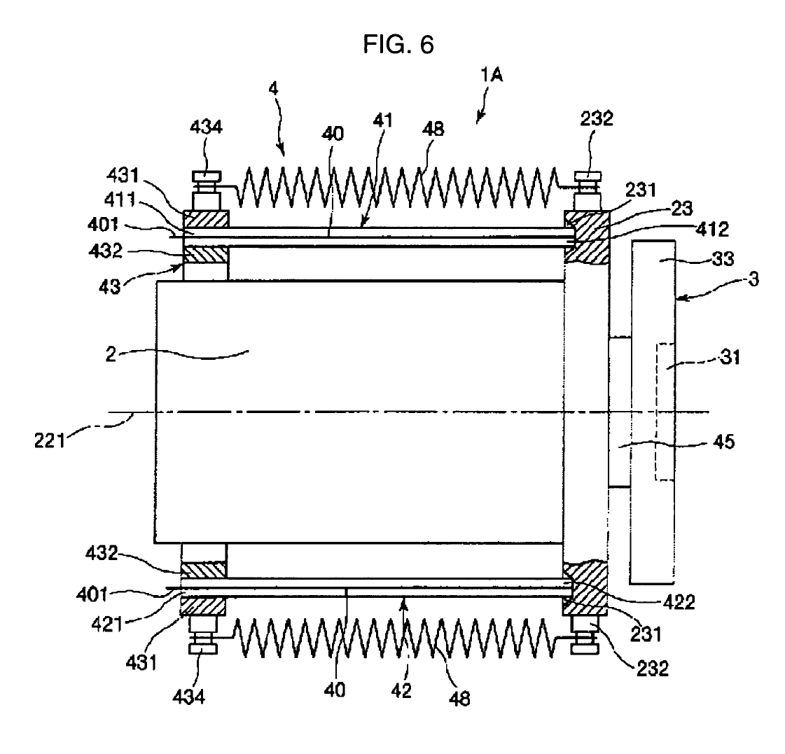

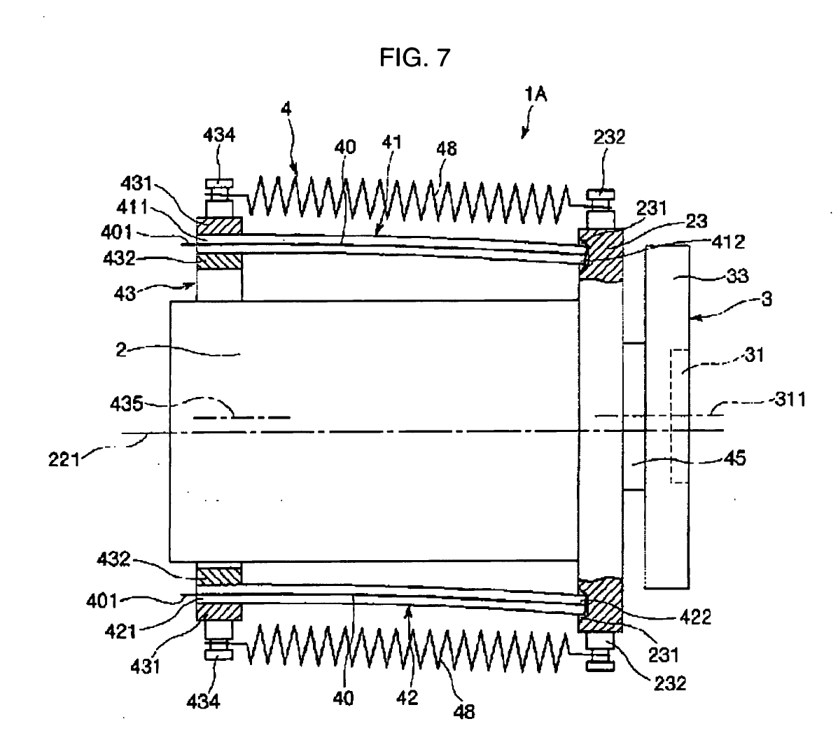

FIG. 5 is a perspective view showing a second embodiment of the image pickup apparatus of the present invention, and FIG. 6 is a side view, partly in cross-section, of the image pickup apparatus 1A shown in FIG. 5. FIG. 7 is a side view, partly in cross-section, in which the first support plates are bent from a state shown in FIG. 6.

The second embodiment is described below with reference to FIGS. 5, 6, and 7, in which only points different from those in the first embodiment are described, and the descriptions of common matters are omitted. Note that the upper side in each of FIGS. 6 and 7 is referred to as an upper side, and the lower side in each of FIGS. 6 and 7 is referred to as a lower side. The left side in FIGS. 6 and 7 is referred to as a front side, and the right side in FIGS. 6 and 7 is referred to as a back side.

As shown in FIG. 5, in the second embodiment, the dispositions of the first support plates 41, 42 and the second support plates 44, 45 are opposite to those of the first embodiment. Namely, the first support plates 41, 42 are disposed at upper and lower sides, and the second support plates 44, 45 are disposed at right and left sides.

The first support plates 41, 42, and the second support plates 44, 45 are bimorph piezoelectric actuators, similarly to the first embodiment. The first support plates 41, 42 have base metal plates 40, forming the electrodes of the bimorph piezoelectric actuators, and first front-end portions 411, 421. Lead portions 401, forming parts of the base metal plates 40, are projected from the first front-end portions 411, 421. The second support plates 44, 45 have base metal plates 40′, forming electrodes of the bimorph piezoelectric actuators, and second front-end portions 441, 451. Lead portions 401′, forming parts of the base metal plates 40, are projected from the second front-end portions 441, 451.

The movable frame 43 has an outer frame 431, and inner frame 432 mounted inside the outer frame 431. Each of the sides of the outer frame 431 is connected to each of the sides of the inner frame 432 through two screws 433.

The first front-end portions 411, 421, and the second front-end portions 441, 451 are sandwiched by the outer frame 431 and the inner frame 432. Thus, the first front-end portions 411, 421, and the second front-end portions 441, 451 are fixed ends, which are fixed to and not inclined relative to the movable frame 43.

The imaging-device board 3 has an imaging-device housing 33, which is plate-shaped, and on which the imaging device 31 is provided (see FIG. 6).

The base 23 has a pair of first grooves 231 at upper and lower portions thereof, with which rear-end portions 412, 422 of the first support plates 41, 42 are engaged. Similarly, the imaging-device housing 33 has a pair of second grooves 331 at right and left portions thereof, with which rear-end portions of the second support plates 44, 45 are engaged.

Two coil springs (or elastic members) 48 are provided between the movable frame 43 and the base 23, in a tensioned state to generate a tensile force. The coil springs 48 are displaced outside the first support plates 41, 42, and parallel to the first support plates 41, 42. Each of the coil springs 48 has hooks at both ends, which are engaged with engaging portions 434, 232, which are pins projecting from the outer peripheral surfaces of the movable frame 43 and the base 23.

Similarly, two coil springs (or elastic members) 49 are provided between the movable frame 43 and the imaging-device housing 33, in a tensioned state to generate a tensile force. The coil springs 49 are displaced outside the second support plates 44, 45, and are parallel to the second support plates 44, 45. Each of the coil springs 49 has hooks at both ends, which are engaged with the engaging portions 434, 332, which are pins projecting from the outer peripheral surfaces of the movable frame 43 and the imaging-device housing 33.

The rear-end portions 412, 422 of the first support plates 41, 42 are free ends, which are not fixed to the base 23, and come into contact with a bottom of the first groove 231 formed in the base 23, due to the tensile force generated by the coil spring 48. Namely, the coil spring 48 functions as a first urging member, which urges the rear-end portions 412, 422 of the first support plates 41, 42 into the first groove 231.

Similarly, the rear-end portions of the second support plates 44, 45 are free ends, which are not fixed to the imaging-device housing 33, and come into contact with a bottom of the second groove 331 formed in the imaging-device housing 33, due to the tensile force generated by coil spring 49. Namely, the coil spring 49 functions as second urging member, which urges the rear-end portions of the second support plates 44, 45 into the second groove 331.

As shown in FIG. 6, the rear-end portions 412, 422 of the first support plates 41, 42 have end surfaces perpendicular to the surfaces of the first support plates 41, 42.

The first groove 231 has a cross section shape in which the breadth gradually decreases in a direction of the depth of the groove 231. Namely, the section profile of the first groove 231 is trapezoid, and the breadth of the bottom of the groove 231 is narrower than that of the opening of the groove 231.

Further, the breadth of the bottom of the first groove 231 is roughly the same as the thickness of each of the first support plates 41, 42, so that the rear-end portions 412, 422 of the first support plates 41, 42 are positioned relative to the base 23, and fixed thereto.

Note that the shapes of the rear-end portions of the second support plates 44, 45 and the second groove 331 are the same as those of the rear-end portions 412, 422 of the first support plates 41, 42 and the first groove 231, and are not shown in the drawings.

Since the rear-end portions of the first support plates 41, 42 and the second support plates 44, 45 have the shapes as described above, in the manufacturing process, the first support plates 41, 42 and the second support plates 44, 45 are obtained by cutting plate material into a predetermined shape, and no further processing is needed for the rear-end portions. Therefore, the rear-end portions of the first support plates 41, 42 and the second support plates 44, 45 are easily manufactured. Further, the first groove 231 and the second groove 331 are easily formed or processed.

In a state shown in FIG. 6, if an electric voltage is applied to the first support plates 41, 42, as shown in FIG. 7, the first support plates 41, 42 are bent, so that the movable frame 43 is displaced in such a manner that the center 435 of the movable frame 43 offsets from the optical axis 221, and the imaging-device board 3 is displaced in such a manner that the center 311 of the imaging device 31 offsets from the optical axis 221.

In this operation, the rear-end portions 412, 422 of the first support plates 41, 42 are freely inclined with respect to the base 23, since the rear-end portions 412, 422 are free ends that are not fixed to the base 23 (see FIG. 7).

Note that, when an electric voltage is applied to the second support plates 44, 45, the rear-ends of the second support plates 44, 45 are freely inclined with respect to the imaging-device housing 33, in a similar way as above.

According to the image pickup apparatus 1A of the second embodiment, the same effect as that of the first embodiment can be obtained.

Further, in the image pickup apparatus 1A of the second embodiment, the rear-end portions of the first support plates 41, 42 and the second support plates 44, 45 directly abut against the base 23 and the imaging-device housing 33 without any connecting member. Therefore, when an electric voltage is applied to each of the first support plates 41, 42, and the second support plates 44, 45 so that the imaging-device board 3 is displaced in a plane perpendicular to the optical axis 221, the first support plates 41, 42, and the second support plates 44, 45 are not affected by the rigidity or the attaching accuracy of the connecting members. Thus, the imaging-device board 3 is exactly displaced by the desired amount, due to the applied voltages to the first support plates 41, 42, and the second support plates 44, 45. As a result, an image-shake compensation control is stably performed through the control unit 7 contained in the first embodiment, with a high accuracy.

Note that, contrary to the above, it is possible that the rear-end portions of the first support plates 41,42, and the second support plates 44, 45 may be rigidly fixed to the imaging-device housing 33, and the front-end portions 441, 451 of the first support plates 41, 42, and the second support plates 44, 45 may be free ends which abut against the movable frame 43.

Further, since the coil springs 48, 49, which are the first and second urging members, are disposed as described above, the image pickup apparatus 1A can be miniaturized, and can generate urging forces which are well balanced.

Note that the first and second urging members are not limited to the coil springs 48, 49, and can be replaced with elastic members such as rubber strings. Further, the first and second urging members may be disposed at other positions than those shown in the drawings.

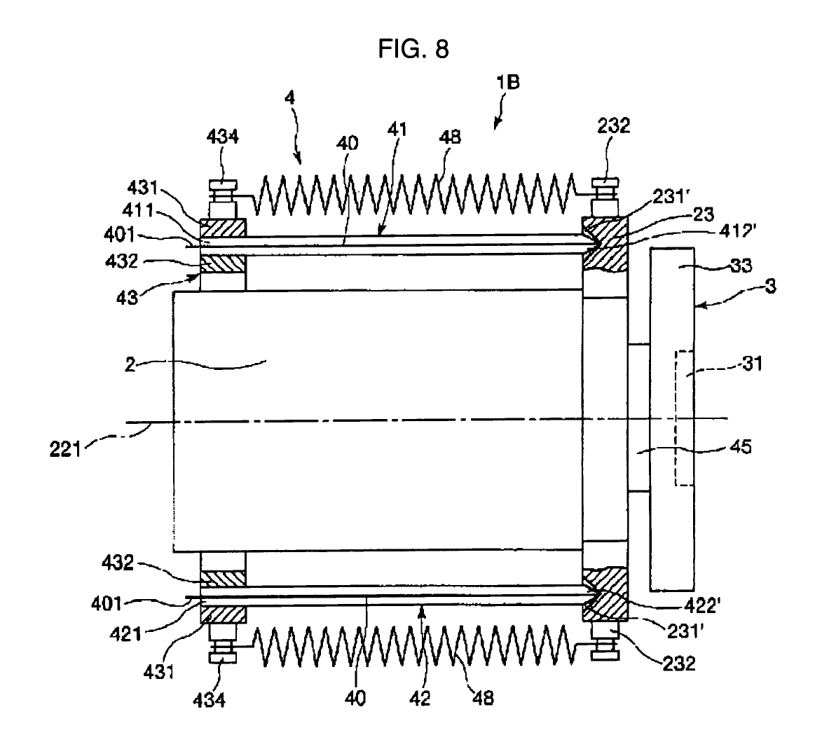

FIG. 8 is a side view, partly in cross-section, in which a third embodiment of the image pickup apparatus of the present invention is shown. The third embodiment is described below with reference to FIG. 8, in which only points different from those in the second embodiment are described, and the descriptions of common matters are omitted.

The image pickup apparatus 1B of the third embodiment has the same structure as that of the second embodiment except for the shapes of rear-end portions 412′, 422′ of the first support plates 41, 42, and the rear-end portions of the second support plates 44, 45, and the shapes of a first groove 231′ and a second groove (not shown) provided for engaging with the second support plates 44, 45.

Namely, the rear-end portions 412′, 422′ of the first support plates 41, 42 are knife-edge-shaped, or have V-shaped sections. The processing or shaping method for the rear-end portions 412′, 422′ is not restricted to a specific process, and may be a grinding process.

The sectional shape of the first groove 231′ has a V-shape in which the breadth is decreased as the depth becomes large, and the angle of V of the first groove 231′ is greater than that of the rear-end portions 412′, 422′.

The apices of the rear-end portions 412′, 422′ are engaged with the bottom angled portions of the first grooves 231′, so that the rear-end portions 412′, 422′ are positioned relative to the base 23, and are prevented from offsetting from that position.

Note that the shapes of the rear-end portions of the second support plates 44, 45 and the second groove are the same as those of the rear-end portions 412′, 422′ of the first support plates 41, 42 and the first groove 231′, and are not shown in the drawings.

According to the image pickup apparatus 1B of the third embodiment, the same effect as that of the second embodiment can be obtained.

Further, in the image pickup apparatus 1B of the third embodiment, since the rear-end portions of the first support plates 41, 42, and the second support plates 44, 45 are knife-edge-shaped, even when the first support plates 41, 42, and the second support plates 44, 45 are bent, the engaging positions of the rear-end portions are always constant. Therefore, an image-shake compensation control is performed with a higher accuracy than the second embodiment.

Note that the sectional shapes of free ends of the first support plates 41, 42, the second support plates 44, 45, and the grooves receiving these plates, are not restricted to those shown in FIGS. 6, 7, and 8. Namely, the sectional shapes may be semicircular, semi-oval, and so on.

The present invention is not restricted to the constructions of the above embodiments. Namely, each part contained in the image pickup apparatus can be changed to another construction having the same function. Further, any other component can be added to the image pickup apparatus.

In the above embodiments, the pair of the first support plates are piezoelectric actuators, but it is possible that only one of the support plates is a piezoelectric actuator, and the other is not a piezoelectric actuator and can be formed of any metal material or synthetic resin material. This is applicable to the second support plates.

Further, the piezoelectric actuator is not restricted to a bimorph-type, but may be another type such as a monomorph type, a unimorph type, or a multimorph type.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application Nos. 2003-392051 (filed on Nov. 21, 2003) and 2004-148214 (filed on May 18, 2004) which are expressly incorporated herein, by reference, in their entireties.

1. An image pickup apparatus comprising:
a photographing optical system;
an imaging-device board that is provided with an imaging device for sensing an object image captured by said photographing optical system;
a base that is stationary;
a pair of first support plates that are disposed parallel to each other with respect to the optical axis of said photographing optical system, said first support plates having first rear-end portions that are supported by said base;
a movable frame that is supported by a first front-end portion of each of said first support plates, and that encloses the optical axis; and
a pair of second support plates that are disposed parallel to each other with respect to the optical axis, and perpendicular to said first support plates, said second support plates having second front-end portions that are supported by said movable frame, and second rear-end portions that support said imaging-device board;
at least one of said first support plates having a piezoelectric actuator that bends, by applying an electric voltage to said piezoelectric actuator, to displace said movable frame relative to said base in a first direction perpendicular to the optical axis;
at least one of said second support plates having a piezoelectric actuator that bends, by applying an electric voltage to said piezoelectric actuator, to displace said imaging-device board relative to said movable frame in a second direction perpendicular to the optical axis and said first direction.

2. An image pickup apparatus according to claim 1, further comprising a controller that controls the application of the electric voltage to said first and second support plates, so that an image shake, occurring when said imaging device senses said object image, is compensated.

3. An image pickup apparatus according to claim 1, further comprising a lens barrel in which said photographing optical system is housed, said base being provided at a rear-end of said lens barrel, said movable frame enclosing said lens barrel.

4. An image pickup apparatus according to claim 1, wherein said piezoelectric actuator is a bimorph type.

5. An image pickup apparatus according to claim 1, wherein one of said first front-end and rear-end portions is connected to one of said movable frame and said base, through a first flexible connecting member, and one of said second front-end and rear-end portions is connected to one of said movable frame and said imaging-device board, through a second flexible connecting member.

6. An image pickup apparatus according to claim 1, wherein:
one of said first front-end and rear-end portions has a first fixed end that is fixed to one of said movable frame and said base, while the other of said first front-end and rear-end portions has a first free end that comes in contact with a first groove formed in one of said movable frame and said base, and
one of said second front-end and rear-end portions has a second fixed end that is fixed to one of said movable frame and said imaging-device board, while the other of said second front-end and rear-end portions has a second free end that comes in contact with a second groove formed in one of said movable frame and said imaging-device board.

7. An image pickup apparatus according to claim 6, further comprising a first urging member that urges said first free end to said first groove, and a second urging member that urges said second free end to said second groove.

8. An image pickup apparatus according to claim 7, wherein said first urging member comprises a first elastic member that is provided between said movable frame and said base to generate a tensile force, and said second urging member comprises a second elastic member that is provided between said movable frame and said imaging-device board to generate a tensile force.

9. An image pickup apparatus according to claim 8, wherein each of said first and second elastic members comprises a coil spring.

10. An image pickup apparatus according to claim 6, wherein said first and second free ends have end surfaces which are perpendicular to the surfaces of said first and second support plates.

11. An image pickup apparatus according to claim 6, wherein said first and second free ends are knife-edge-shaped.

12. An image pickup apparatus according to claim 6, wherein each of said first and second grooves has a cross section shape in which the breadth gradually decreases in a direction of the depth of the groove.

13. An image pickup apparatus comprising:
a photographing optical system fixed to a stationary portion;
an imaging-device board that is provided with an imaging device for sensing an object image captured by said photographing optical system;
a movable frame that encloses said photographing optical system, and that can move relative to said photographing optical system;
a pair of first support plates that are disposed parallel to each other with respect to the optical axis of said photographing optical system, said first support plates having first rear-end portions connected to said stationary portion, and first front-end portions connected to said movable frame; and
a pair of second support plates that are disposed parallel to each other with respect to the optical axis, and perpendicular to said first support plates, said second support plates having second front-end portions connected to said movable frame, and second rear-end portions connected to said imaging-device board;
at least one of said first support plates having a piezoelectric actuator that bends, by applying an electric voltage to said piezoelectric actuator, to displace said movable frame relative to said base in a first direction perpendicular to the optical axis;
at least one of said second support plates having a piezoelectric actuator that bends, by applying an electric voltage to said piezoelectric actuator, to displace said imaging-device board relative to said movable frame in a second direction perpendicular to the optical axis and said first direction.
